(19) United States
(12) Patent Application Publication
(10) Pub. No.: US 2014/0192096 A1
(43) Pub. Date: Jul. 10, 2014

(54) LIQUID CRYSTAL DISPLAY DEVICE

(71) Applicant: Panasonic Liquid Crystal Display Co., Ltd., Himeji-shi (JP)

(72) Inventors: Junichi MARUYAMA, Osaka (JP); Ryutaro OKE, Osaka (JP); Takashi NAKAI, Osaka (JP); Isamu SHIGEMOTO, Tokyo (JP); Wataru KAWAZOE, Tokyo (JP)

(73) Assignee: Panasonic Liquid Crystal Display Co., Ltd., Himeji-shi (JP)

(21) Appl. No.: 14/148,162

(22) Filed: Jan. 6, 2014

(30) Foreign Application Priority Data
Jan. 7, 2013 (JP) 2013-000704

(51) Int. Cl. G09G 3/36

(52) U.S. Cl. CPC G09G 3/3696
USPC 345/690; 345/89

(57) ABSTRACT

Provided is a liquid crystal display device, including: a first analog power supply circuit that outputs, to each data signal line driving circuit, a first analog voltage generated based on a power supply voltage of an external power supply; a second analog power supply circuit that outputs a second analog voltage based on the first analog voltage; and a reference voltage generating circuit that generates a reference voltage based on the second analog voltage, in which the each data signal line driving circuit generates a gray-scale voltage based on the reference voltage.

### CROSS-REFERENCE TO RELATED APPLICATION

The present application claims priority from Japanese application JP2013-000704 filed on Jan. 7, 2013, the content of which is hereby incorporated by reference into this application.

### BACKGROUND OF THE INVENTION

1. Field of the Invention

The present invention relates to a liquid crystal display device, and more particularly, to a liquid crystal display device including a display portion divided into a plurality of regions that are driven at the same time.

2. Description of the Related Art

In recent years, higher resolution of a liquid crystal display device has caused a shortage of a writing time period (charging and discharging time period) for each pixel. In order to take measures against the shortage, there has been proposed a technology involving dividing a display portion into a plurality of regions (for example, two upper and lower regions), and driving the respective regions at the same time (screen division drive system, see, for example, Japanese Patent Application Laid-open No. 2006-343556).

In a liquid crystal display device of the screen division drive system, scanning signal lines of the respective regions can be selected at the same time, which enables increase in selection time period per single scanning signal line. With this, the shortage of the writing time period for each pixel can be solved.

### SUMMARY OF THE INVENTION

However, the related art has a problem in that display in one of the two divided regions affects display in the other region, which degrades the display quality as the entire screen. This problem is described below with a specific example.

FIG. 9 is a plan view illustrating a schematic configuration of the related-art liquid crystal display device of the screen division drive system. As illustrated in FIG. 9, the liquid crystal display device includes, correspondingly to a first region (upper region), a first data signal line driving circuit (first SD), a first scanning signal line driving circuit (first GD), first data signal lines SLa, and first scanning signal lines GLa. The liquid crystal display device further includes, correspondingly to a second region (lower region), a second data signal line driving circuit (second SD), a second scanning signal line driving circuit (second GD), second data signal lines SLb, and second scanning signal lines GLb.

In the above-mentioned configuration, each of the first data signal line driving circuit and the second data signal line driving circuit inputs a reference voltage Vi for generating a voltage (gray-scale voltage) to be supplied to each of the data signal lines. FIG. 10 is a circuit diagram illustrating a schematic configuration of a reference voltage generating circuit. The reference voltage generating circuit has an input portion connected to an output portion of an analog power supply circuit. The analog power supply circuit converts (for example, boosts) a power supply voltage input from an external power supply to generate an analog power supply voltage (AVDD), and outputs the generated AVDD to the reference voltage generating circuit. The reference voltage generating circuit generates the reference voltage Vi based on the AVDD, and outputs the generated reference voltage Vi to each of the data signal line driving circuits.

Now, a case where the above-mentioned liquid crystal display device displays an image illustrated in FIG. 11 is considered. The image of FIG. 11 includes, in a scanning direction (downward in the drawing sheet) from an upper end portion in the first region, a halftone region, a black region, a white region, and a halftone region. The image of FIG. 11 further includes, in the entire second region, a halftone region. The first region includes images in which the potential of image data significantly varies (for example, the black region and the white region). When such an image is displayed, due to the potential variation of the image data, a ripple is generated in the AVDD output from the analog power supply circuit. Then, the AVDD including the ripple is input to the reference voltage generating circuit to cause fluctuation in the reference voltage Vi.

FIG. 12 is a graph showing the relationship between the gray-scale and the fluctuated reference voltage Vi (output voltage of the reference voltage generating circuit). As shown in FIG. 12, when the reference voltage Vi fluctuates, the output voltage (gray-scale voltage) of the data signal line driving circuit also fluctuates. Therefore, desired display brightness may not be obtained, and the display quality of the liquid crystal panel is degraded.

FIG. 13 is a timing chart of the case where the above-mentioned liquid crystal display device displays the image illustrated in FIG. 11. In FIG. 13, Vp2 represents a potential of a pixel in a second row in the first region, which is selected during a second horizontal scanning period (second H), and Vp3 represents a potential of a pixel in a third row in the first region, which is selected during a third horizontal scanning period (third H). Further, Vp8 represents a potential of a pixel in a second row in the second region, which is selected during the second horizontal scanning period (second H), and Vp9 represents a potential of a pixel in a third row in the second region, which is selected during the third horizontal scanning period (third H). Note that, the second row of the first region is included in the black region of FIG. 11, and the third row of the first region is included in the white region of FIG. 11.

As illustrated in FIG. 13, it is found that, at a timing when the potential of image data S1 significantly changes (for example, timing of switching from (n-th)·H to (n+1)th·H), the reference voltage Vi fluctuates, and the pixel potential Vp9 of the second region fluctuates (increases). Specifically, the pixel potential Vp9 is higher than an original potential (halftone). In this manner, as illustrated in FIG. 14, in the second region, a region having brightness different from the original brightness (so-called ghost) is generated. Note that, when the second region includes regions in which the potential of image data significantly varies, similarly, a ghost is generated in the first region.

The present invention has been made in view of the above-mentioned problem, and has an object to prevent degrading of the display quality in a liquid crystal display device of a screen division drive system.

In order to solve the above-mentioned problem, according to one embodiment of the present invention, there is provided a liquid crystal display device, including: a liquid crystal panel including a display portion divided into a plurality of regions that are driven at the same time; data signal line driving circuits and data signal lines that are individually provided to the respective plurality of regions; a first analog power supply circuit that is connected to an external power supply, and outputs a first analog voltage to each of the data signal line driving circuits, the first analog voltage being generated based on a power supply voltage output from the external power supply; a second analog power supply circuit that is connected to the first analog power supply circuit, and outputs a second analog voltage for generating a reference voltage based on the first analog voltage output from the first analog power supply circuit; and a reference voltage generating circuit that is connected to the second analog power supply circuit, generates the reference voltage based on the second analog voltage output from the second analog power supply circuit, and outputs the generated reference voltage to the each of the data signal line driving circuits, in which the each of the data signal line driving circuits generates, based on the reference voltage, a gray-scale voltage to be supplied to each of the data signal lines.

In the liquid crystal display device according to one embodiment of the present invention, the first analog power supply circuit and the second analog power supply circuit may have different circuit configurations.

In the liquid crystal display device according to one embodiment of the present invention, the first analog power supply circuit may have a configuration of a switching regulator, and the second analog power supply circuit may have a configuration of a linear regulator.

In order to solve the above-mentioned problem, according to one embodiment of the present invention, there is provided a liquid crystal display device, including: a liquid crystal panel including a display portion divided into a plurality of regions that are driven at the same time; data signal line driving circuits and data signal lines that are individually provided to the respective plurality of regions; a first analog power supply circuit that is connected to an external power supply, and outputs a first analog voltage to each of the data signal line driving circuits, the first analog voltage being generated based on a power supply voltage output from the external power supply; a second analog power supply circuit that is connected to the external power supply, and outputs a second analog voltage for generating a reference voltage based on the power supply voltage output from the external power supply; and a reference voltage generating circuit that is connected to the second analog power supply circuit, generates the reference voltage based on the second analog voltage output from the second analog power supply circuit, and outputs the generated reference voltage to the each of the data signal line driving circuits, in which the each of the data signal line driving circuits generates, based on the reference voltage, a gray-scale voltage to be supplied to each of the data signal lines.

In the liquid crystal display device according to one embodiment of the present invention, the first analog power supply circuit and the second analog power supply circuit may each have the same circuit configuration.

In the liquid crystal display device according to one embodiment of the present invention, the first analog power supply circuit and the second analog power supply circuit may each have a configuration of one of a switching regulator and a linear regulator.

In order to solve the above-mentioned problem, according to one embodiment of the present invention, there is provided a liquid crystal display device, including: a liquid crystal panel including a display portion divided into a plurality of regions that are driven at the same time; a plurality of data signal line driving circuits and data signal lines that are individually provided to the respective plurality of regions, the plurality of data signal line driving circuits including a first data signal line driving circuit and a second data signal line driving circuit; a first analog power supply circuit that is connected to an external power supply, and outputs, to the first data signal line driving circuit, a first analog voltage generated based on a power supply voltage output from the external power supply; a second analog power supply circuit that is connected to the external power supply, and outputs a second analog voltage for generating a reference voltage based on the power supply voltage output from the external power supply; a third analog power supply circuit that is connected to the external power supply, and outputs, to the second data signal line driving circuit, a third analog voltage generated based on the power supply voltage output from the external power supply; and a reference voltage generating circuit that is connected to the second analog power supply circuit, generates the reference voltage based on the second analog voltage output from the second analog power supply circuit, and outputs the generated reference voltage to each of the first data signal line driving circuit and the second data signal line driving circuit, in which each of the first data signal line driving circuit and the second data signal line driving circuit generates, based on the reference voltage, a gray-scale voltage to be supplied to each of the data signal lines.

In the liquid crystal display device according to one embodiment of the present invention, the first analog power supply circuit, the second analog power supply circuit, and the third analog power supply circuit may each have the same circuit configuration.

In the liquid crystal display device according to one embodiment of the present invention, the first analog power supply circuit, the second analog power supply circuit, and the third analog power supply circuit may each have a configuration of one of a switching regulator and a linear regulator.

### BRIEF DESCRIPTION OF THE DRAWINGS

FIG. 1 is a plan view illustrating an example of a schematic configuration of a liquid crystal display device according to a first embodiment of the present invention.

FIG. 2 is a timing chart illustrating the operation of the liquid crystal display device according to the first embodiment.

FIG. 3 is a graph showing a relationship between gray-scale and an output voltage.

FIG. 4 is a circuit diagram illustrating a specific configuration of a first analog power supply circuit.

FIG. 5 is a circuit diagram illustrating a specific configuration of a second analog power supply circuit.

FIG. 6 is a plan view illustrating an example of a schematic configuration of a liquid crystal display device according to a second embodiment of the present invention.

FIG. 7 is a plan view illustrating an example of a schematic configuration of a liquid crystal display device according to a third embodiment of the present invention.

FIG. 8 is a timing chart illustrating the operation of the liquid crystal display device according to the third embodiment.

FIG. 9 is a plan view illustrating a schematic configuration of a related-art liquid crystal display device of a screen division drive system.

FIG. 10 is a circuit diagram illustrating a schematic configuration of a reference voltage generating circuit.

FIG. 11 is a diagram illustrating an example of a display image.

FIG. 12 is a graph showing a relationship between gray-scale and a fluctuated reference voltage (output voltage).

FIG. 13 is a timing chart illustrating the operation of the related-art liquid crystal display device.

FIG. 14 is a diagram illustrating an example of a display image caused by the operation of FIG. 13.

### DETAILED DESCRIPTION OF THE INVENTION

### First Embodiment

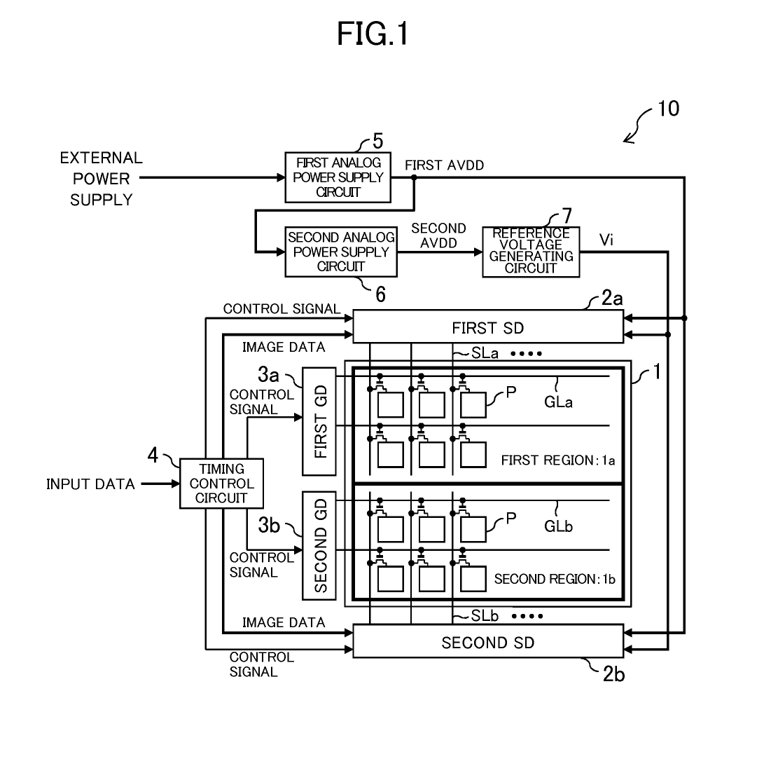

A first embodiment of the present invention is described below with reference to the drawings. FIG. 1 is a plan view illustrating an example of a schematic configuration of a liquid crystal display device 10 according to the first embodiment. The liquid crystal display device 10 includes a liquid crystal panel 1 including a display portion divided into a first region 1a and a second region 1b, a first data signal line driving circuit 2a (first SD), a second data signal line driving circuit 2b (second SD), a first scanning signal line driving circuit 3a (first GD), a second scanning signal line driving circuit 3b (second GD), a timing control circuit 4, a first analog power supply circuit 5, a second analog power supply circuit 6, and a reference voltage generating circuit 7.

In the first region 1a of the liquid crystal panel 1, a plurality of first data signal lines SLa connected to the first data signal line driving circuit 2a and a plurality of first scanning signal lines GLa connected to the first scanning signal line driving circuit 3a are provided, and a transistor (TFT) is provided at each intersecting portion between the first data signal line SLa and the first scanning signal line GLa. In the second region 1b of the liquid crystal panel 1, a plurality of second data signal lines SLb connected to the second data signal line driving circuit 2b and a plurality of second scanning signal lines GLb connected to the second scanning signal line driving circuit 3b are provided, and a transistor (TFT) is provided at each intersecting portion between the second data signal line SLb and the second scanning signal line GLb. The first data signal line SLa and the second data signal line SLb are independent from each other and are driven individually.

In the liquid crystal panel 1, a plurality of pixels P are arranged in matrix (row direction and column direction) so as to correspond to the respective intersecting portions. Note that, although not illustrated, the liquid crystal panel 1 includes a TFT substrate, a counter substrate, a liquid crystal layer sandwiched between both the substrates, a pixel electrode provided to the TFT substrate, and a counter electrode provided to the counter substrate. A known configuration may be applied to the liquid crystal panel 1.

The first data signal line driving circuit 2a and the first scanning signal line driving circuit 3a drive the first data signal lines SLa and the first scanning signal lines GLa in the first region 1a, respectively. The second data signal line driving circuit 2b and the second scanning signal line driving circuit 3b drive the second data signal lines SLb and the second scanning signal lines GLb in the second region 1b, respectively. The timing control circuit 4 and the reference voltage generating circuit 7 are provided in common to the first region 1a and the second region 1b.

The first analog power supply circuit 5 has an input portion connected to an external power supply, and an output portion connected to each of the second analog power supply circuit 6, the first data signal line driving circuit 2a, and the second data signal line driving circuit 2b. The first analog power supply circuit 5 converts (boosts or bucks) a power supply voltage input from the external power supply to generate an analog power supply voltage (first AVDD). The first analog power supply circuit 5 outputs (supplies) the generated first AVDD to each of the second analog power supply circuit 6, the first data signal line driving circuit 2a, and the second data signal line driving circuit 2b. The specific configuration of the first analog power supply circuit 5 is described later.

The second analog power supply circuit 6 has an input portion connected to the output portion of the first analog power supply circuit 5, and an output portion connected to an input portion of the reference voltage generating circuit 7. The second analog power supply circuit 6 converts the first AVDD input from the first analog power supply circuit 5 into a predetermined analog power supply voltage (second AVDD). The second analog power supply circuit 6 outputs (supplies) the second AVDD obtained through conversion to the reference voltage generating circuit 7. The specific configuration of the second analog power supply circuit 6 is described later.

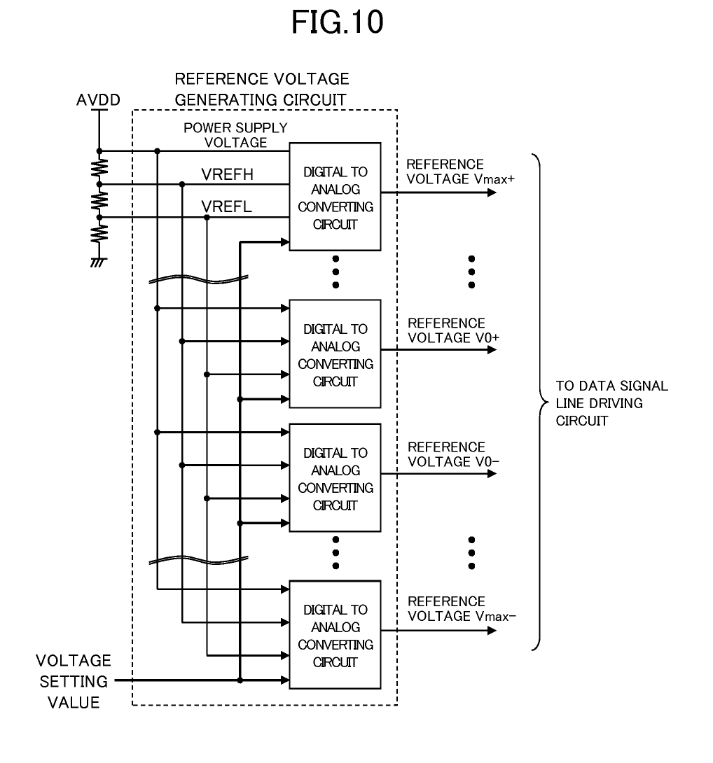

The input portion of the reference voltage generating circuit 7 is connected to the output portion of the second analog power supply circuit 6, and an output portion thereof is connected to each of the first data signal line driving circuit 2a and the second data signal line driving circuit 2b. The reference voltage generating circuit 7 generates the reference voltage Vi based on the second AVDD input from the second analog power supply circuit 6. The reference voltage generating circuit 7 outputs (supplies) the generated reference voltage Vi to each of the first data signal line driving circuit 2a and the second data signal line driving circuit 2b. A known configuration (for example, the configuration illustrated in FIG. 10) may be applied to the reference voltage generating circuit 7.

The timing control circuit 4 outputs, based on input data (such as a synchronization signal and a video signal) input from the outside, a control signal for controlling a drive timing of each of the first data signal line driving circuit 2a, the first scanning signal line driving circuit 3a, the second data signal line driving circuit 2b, and the second scanning signal line driving circuit 3b, image data of an image to be displayed in the first region 1a, and image data of an image to be displayed in the second region 1b.

The first data signal line driving circuit 2a outputs, based on the control signal and the image data input from the timing control circuit 4 and the reference voltage Vi input from the reference voltage generating circuit 7, a gray-scale voltage to each of the first data signal lines SLa.

The second data signal line driving circuit 2b outputs, based on the control signal and the image data input from the timing control circuit 4 and the reference voltage Vi input from the reference voltage generating circuit 7, a gray-scale voltage to each of the second data signal lines SLb.

The first scanning signal line driving circuit 3a and the second scanning signal line driving circuit 3b output, based on the control signals input from the timing control circuit 4, scanning signals to the scanning signal lines GLa and GLb, respectively. Further, the first scanning signal line driving circuit 3a and the second scanning signal line driving circuit 3b simultaneously scan the scanning signal lines GLa in the first region 1a and the scanning signal lines GLb in the second region 1b.

In the liquid crystal panel 1, when a transistor connected to a scanning signal line is turned on by a scanning signal, a gray-scale voltage is applied from a data signal line to a pixel electrode of a pixel connected to the transistor. With this, an image corresponding to the gray-scale is displayed on the liquid crystal panel 1. Further, the liquid crystal display device 10 has a configuration (screen division drive system) in which the scanning signal lines (GLa and GLb) in the first region 1a and the second region 1b are selected at the same time to drive the first region 1a and the second region 1b at the same time. A known method may be applied to the driving method in the screen division drive system.

### <Operation of Liquid Crystal Display Device 10>

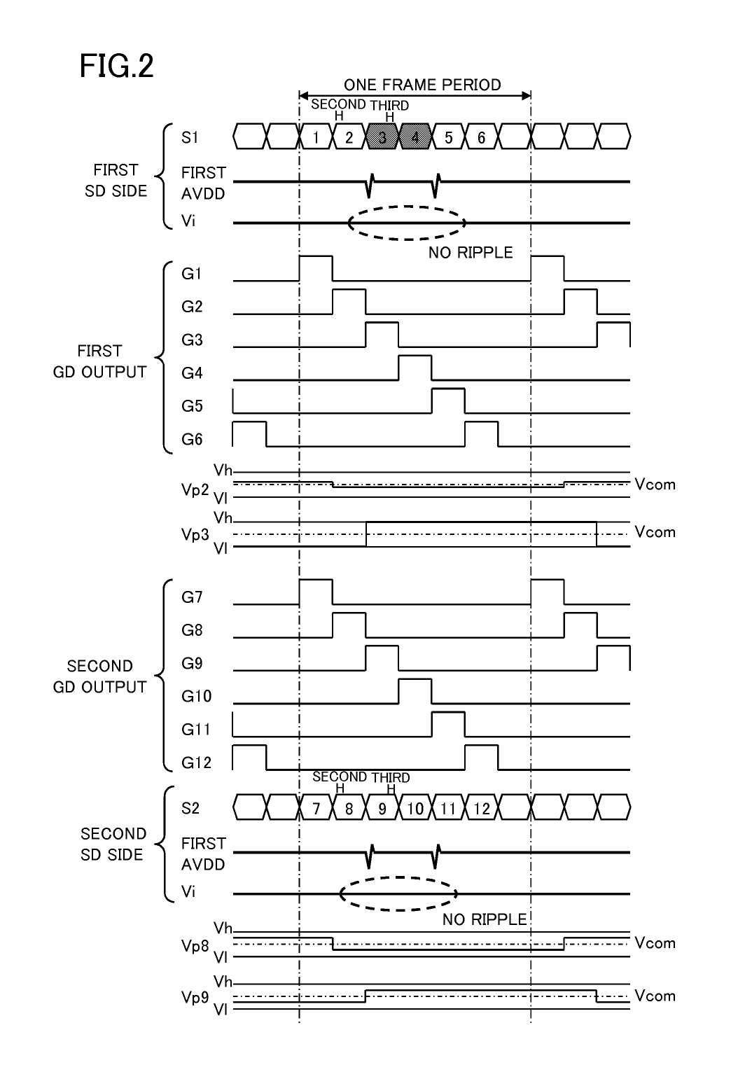

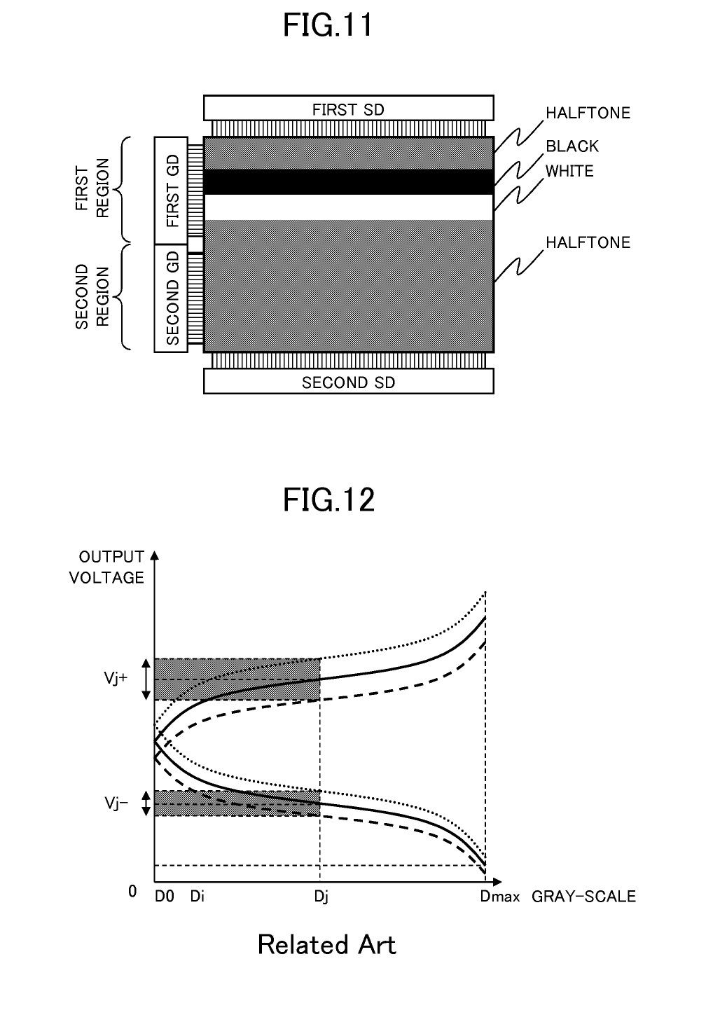

FIG. 2 is a timing chart illustrating the operation of the liquid crystal display device 10. Note that, FIG. 2 illustrates a timing chart of a case where the liquid crystal display device 10 displays an image illustrated in FIG. 11. In FIG. 2, S1 represents image data of the first data signal line driving circuit 2a, S2 represents image data of the second data signal line driving circuit 2b, FIRST AVDD represents an analog power supply voltage output from the first analog power supply circuit 5, Vi represents a reference voltage output from the reference voltage generating circuit 7, G1 to G6 represent scanning signals output from the first scanning signal line driving circuit 3a, and G7 to G12 represent scanning signals output from the second scanning signal line driving circuit 3b. Vp2 represents a potential of a pixel in a second row in the first region 1a, which is selected during a second horizontal scanning period (second H), and Vp3 represents a potential of a pixel in a third row in the first region 1a, which is selected during a third horizontal scanning period (third H). Further, Vp8 represents a potential of a pixel in a second row in the second region 1b, which is selected during the second horizontal scanning period (second H), and Vp9 represents a potential of a pixel in a third row in the second region 1b, which is selected during the third horizontal scanning period (third H). Note that, the second row of the first region 1a is included in the black region of FIG. 11, and the third row of the first region 1a is included in the white region of FIG. 11.

In the image of FIG. 11, as described above, the first region 1a includes images in which the potential of image data significantly varies (for example, the black region and the white region). Therefore, for example, at a timing of switching from the second H to the third H, a ripple (voltage fluctuation) is generated in the first AVDD.

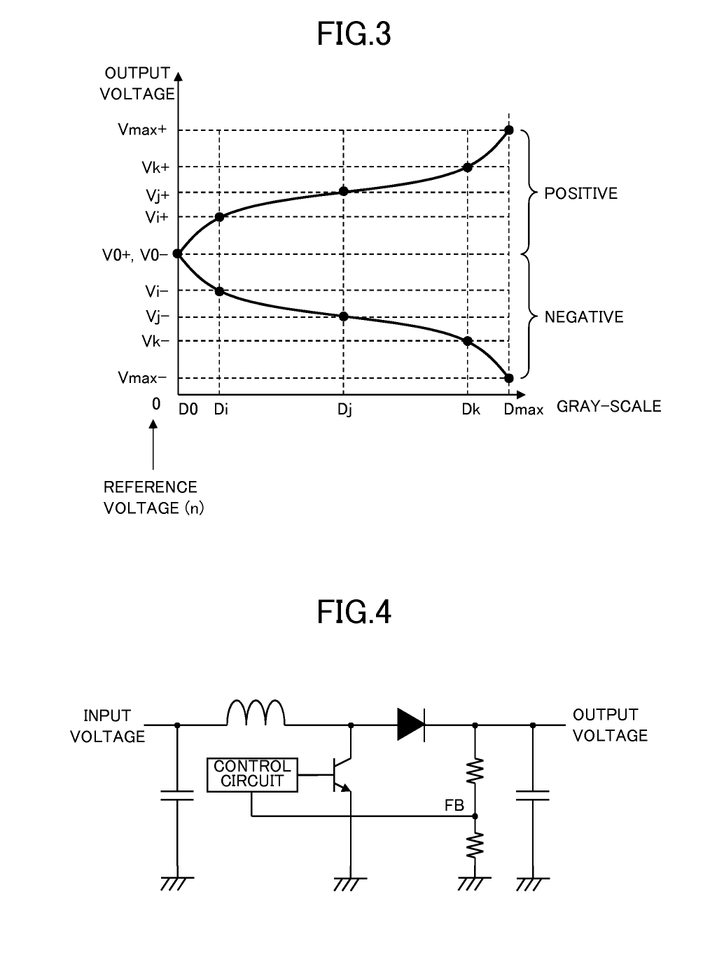

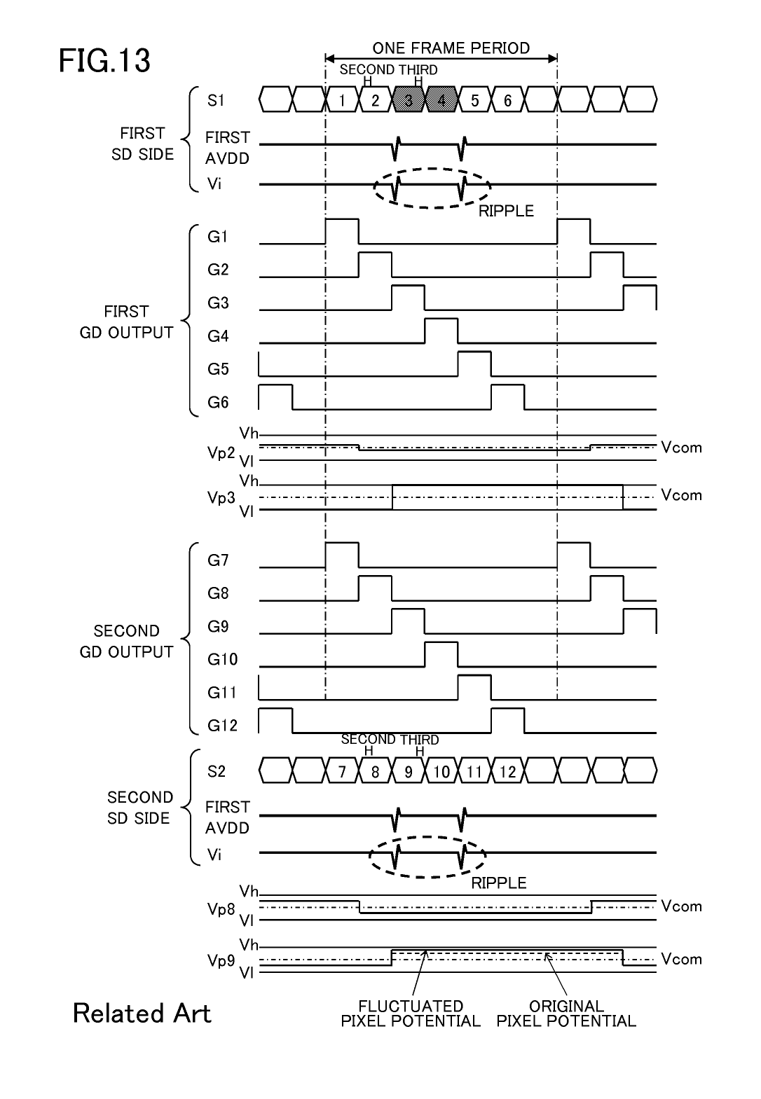

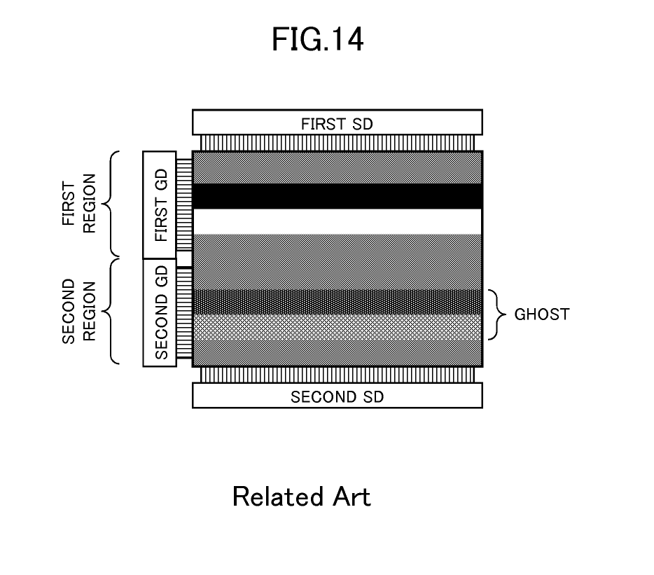

In the liquid crystal display device 10, the fluctuated first AVDD is input to the second analog power supply circuit 6. The second analog power supply circuit 6 converts an input voltage into a predetermined voltage, and hence even when the input voltage includes a ripple, the ripple is removed and the predetermined voltage is output. Therefore, the first AVDD including a ripple is converted into a ripple-free second AVDD by the second analog power supply circuit 6. The ripple-free second AVDD is input to the reference voltage generating circuit 7, and hence a fluctuation-free reference voltage Vi is generated (see FIG. 2). Then, the fluctuation-free reference voltage Vi is input to each of the first data signal line driving circuit 2a and the second data signal line driving circuit 2b. Therefore, as shown in FIG. 3, a desired output voltage (gray-scale voltage) can be output to each data signal line in accordance with the gray-scale. For example, as illustrated in FIG. 2, the pixel potential Vp9 in the second region 1b exhibits a desired potential-fluctuation-free gray-scale voltage (halftone), as compared to the pixel potential Vp9 illustrated in FIG. 13. With this, generation of a ghost illustrated in FIG. 14 can be suppressed, and hence degrading of display quality of the liquid crystal panel 1 can be prevented.

As described above, with the configuration of the liquid crystal display device 10, fluctuation (ripple) in the power supply voltage (second AVDD) to be input to the reference voltage generating circuit 7 can be suppressed. In this manner, a desired gray-scale voltage can be supplied to each data signal line, and degrading of display quality can be prevented.

### <Configuration of First Analog Power Supply Circuit 5>

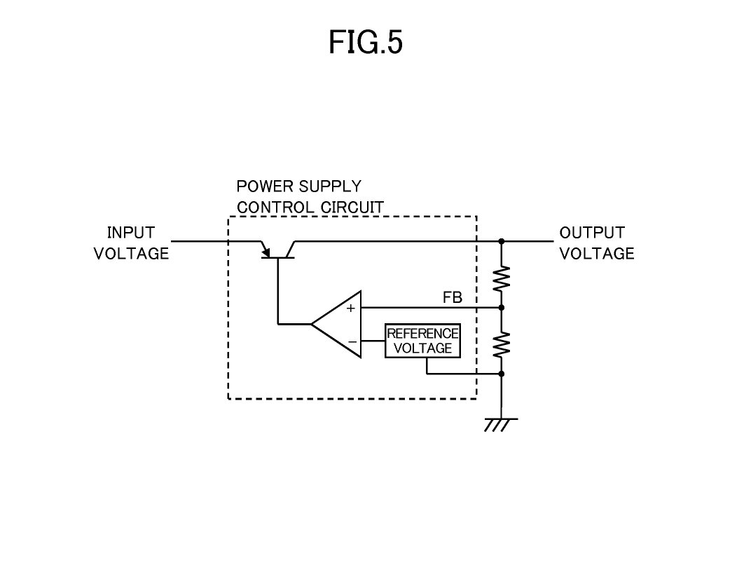

FIG. 4 is a circuit diagram illustrating a specific configuration of the first analog power supply circuit 5. As illustrated in FIG. 4, the first analog power supply circuit 5 has a configuration of a switching regulator, and includes a transistor, a coil, resistors, capacitors, a diode, and a control circuit. The first analog power supply circuit 5 controls an ON/OFF time of a switching element while monitoring the output voltage, to thereby convert an input voltage into a desired output voltage. For example, the first analog power supply circuit 5 executes such a control of turning off the switching element when the output voltage is higher than a desired value, and in contrast, turning on the switching element when the output voltage is lower than the desired value. FIG. 4 illustrates a boost switching regulator, which, for example, converts an input voltage of 12 V into an output voltage of 16 V. Note that, the first analog power supply circuit 5 is not limited to the boost switching regulator. A buck or buck-boost switching regulator may be applied in accordance with the difference in magnitude between the input voltage and the output voltage.

### <Configuration of Second Analog Power Supply Circuit 6>

FIG. 5 is a circuit diagram illustrating a specific configuration of the second analog power supply circuit 6. As illustrated in FIG. 5, the second analog power supply circuit 6 has a configuration of a linear regulator, and includes a transistor, a comparator circuit, resistors, and a reference voltage. The second analog power supply circuit 6 is a stabilized power supply circuit for bucking and rectifying an input voltage, and then outputting the stabilized power. Therefore, the ripple in the input voltage can be removed, and the stabilized voltage can be output. For example, an input voltage of 16 V including a ripple can be converted into a stabilized ripple-free output voltage of 15 V. Further, the second analog power supply circuit 6 has an advantage in that the structure is simpler and the cost is lower than the case of the first analog power supply circuit 5 (switching regulator).

### Second Embodiment

A second embodiment of the present invention is described below with reference to the drawings. Note that, for convenience of the description, a member having the same function as that of the member described in the first embodiment is denoted by the same reference numeral (and symbol) and the description thereof is omitted. Further, the terms defined in the first embodiment are used in accordance with their definitions also in this embodiment unless otherwise specified.

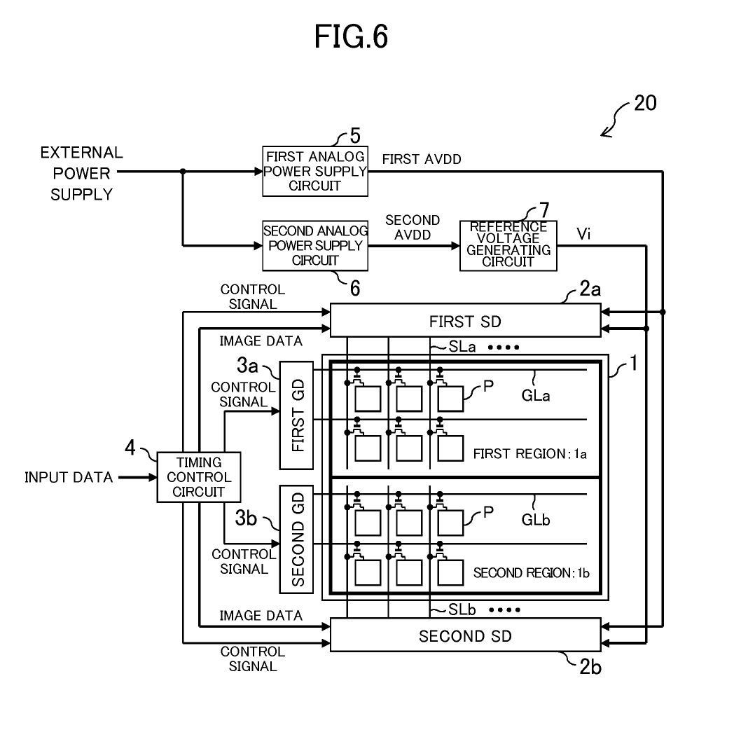

FIG. 6 is a plan view illustrating an example of a schematic configuration of a liquid crystal display device 20 according to a second embodiment of the present invention. In the liquid crystal display device 20, the input portion of the first analog power supply circuit 5 is connected to the external power supply, and the output portion thereof is connected to each of the first data signal line driving circuit 2a and the second data signal line driving circuit 2b. Further, the input portion of the second analog power supply circuit 6 is connected to the external power supply, and the output portion thereof is connected to the reference voltage generating circuit 7. The second analog power supply circuit 6 has the same configuration as the first analog power supply circuit 5, and is formed as a switching regulator (see FIG. 4). Other configurations are the same as those of the liquid crystal display device 10 according to the first embodiment. Note that, when a difference between an input voltage input from the external power supply and a desired output voltage output from each of the first analog power supply circuit 5 and the second analog power supply circuit 6 is small, each of the first analog power supply circuit 5 and the second analog power supply circuit 6 may be formed as a linear regulator (see FIG. 5).

The operation of the liquid crystal display device 20 is the same as the operation of the liquid crystal display device 10 according to the first embodiment (see FIG. 2).

In the configuration of the liquid crystal display device 20, the input voltage input to the second analog power supply circuit 6 is the power supply voltage input from the external power supply, which is not affected by the potential variation of image data. Therefore, a ripple-free second AVDD is output from the second analog power supply circuit 6. The ripple-free second AVDD is input to the reference voltage generating circuit 7, and hence a fluctuation-free reference voltage Vi is generated (see FIG. 2). Then, the fluctuation-free reference voltage Vi is input to each of the first data signal line driving circuit 2a and the second data signal line driving circuit 2b. Therefore, as shown in FIG. 3, a desired output voltage (gray-scale voltage) can be output to each data signal line in accordance with the gray-scale. With this, degrading of the display quality of the liquid crystal panel 1 can be prevented.

### Third Embodiment

A third embodiment of the present invention is described below with reference to the drawings. Note that, for convenience of the description, a member having the same function as that of the member described in the first embodiment is denoted by the same reference numeral (and symbol) and the description thereof is omitted. Further, the terms defined in the first and second embodiments are used in accordance with their definitions also in this embodiment unless otherwise specified.

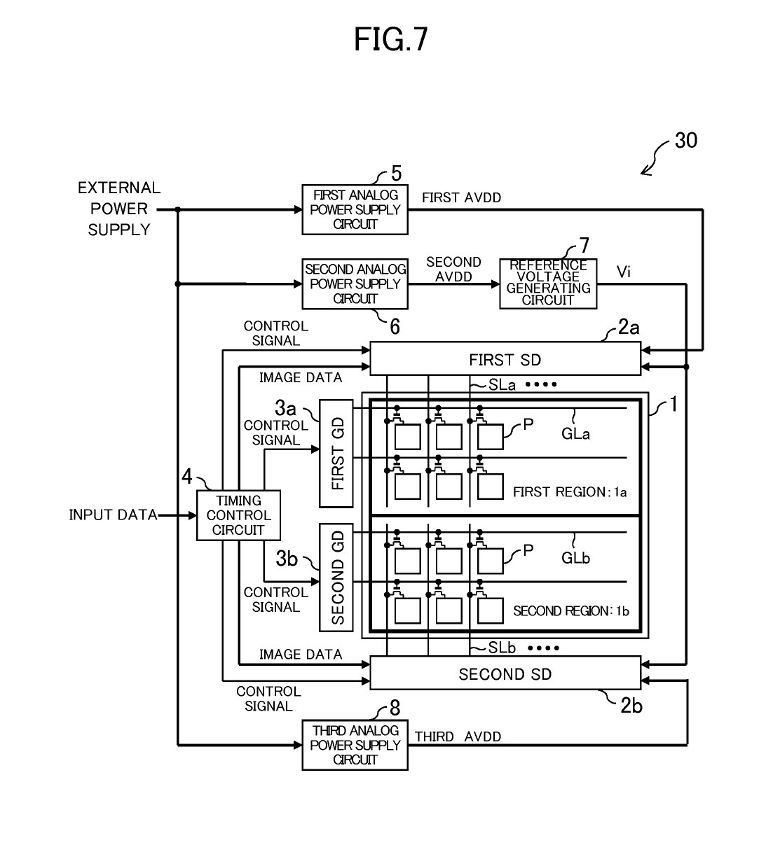

FIG. 7 is a plan view illustrating an example of a schematic configuration of a liquid crystal display device 30 according to a third embodiment of the present invention. The liquid crystal display device 30 includes a third analog power supply circuit 8 in addition to the configuration (see FIG. 6) of the liquid crystal display device 20 according to the second embodiment. In the liquid crystal display device 30, the input portion of the first analog power supply circuit 5 is connected to the external power supply, and the output portion thereof is connected to the first data signal line driving circuit 2a. Further, the input portion of the second analog power supply circuit 6 is connected to the external power supply, and the output portion thereof is connected to the reference voltage generating circuit 7. Further, the third analog power supply circuit 8 has an input portion connected to the external power supply, and an output portion connected to the second data signal line driving circuit 2b.

Each of the first analog power supply circuit 5, the second analog power supply circuit 6, and the third analog power supply circuit 8 is formed as a switching regulator (see FIG. 4). Other configurations are the same as those of the liquid crystal display device 20 according to the second embodiment. Note that, when a difference between an input voltage input from the external power supply and a desired output voltage output from each of the first analog power supply circuit 5, the second analog power supply circuit 6, and the third analog power supply circuit 8 is small, each of the analog power supply circuits maybe formed as a linear regulator (see FIG. 5).

The first analog power supply circuit 5 outputs, to the first data signal line driving circuit 2a, a power supply voltage (first AVDD) generated based on the power supply voltage input from the external power supply. The second analog power supply circuit 6 outputs, to the reference voltage generating circuit 7, a power supply voltage (second AVDD) generated based on the power supply voltage input from the external power supply. The third analog power supply circuit 8 outputs, to the second data signal line driving circuit 2b, a power supply voltage (third AVDD) generated based on the power supply voltage input from the external power supply.

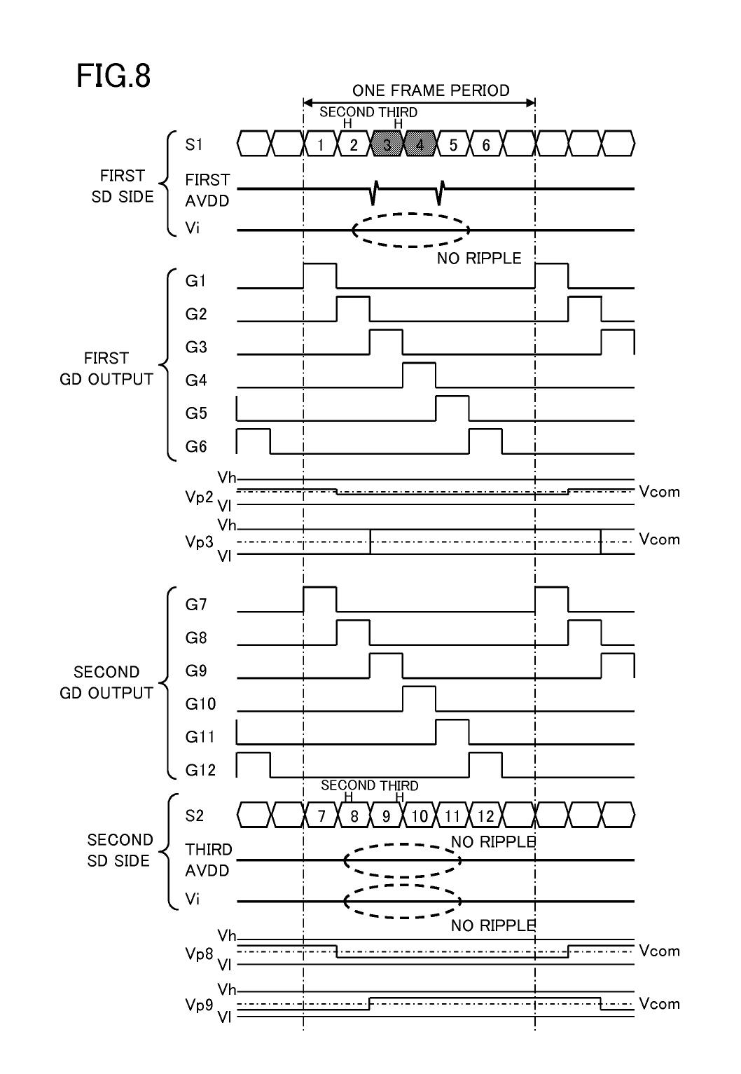

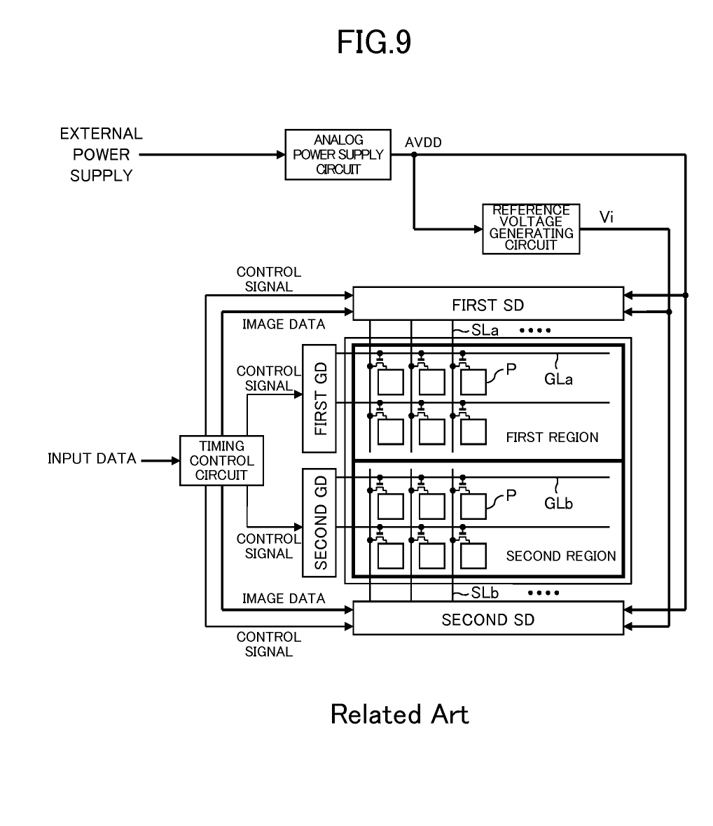

FIG. 8 is a timing chart illustrating the operation of the liquid crystal display device 30. In the liquid crystal display device 30, the third analog power supply circuit 8 is separated from the first data signal line driving circuit 2a, and hence the power supply voltage (third AVDD) to be input to the second data signal line driving circuit 2b is not affected by the potential variation of image data in the first data signal line driving circuit 2a (first region 1a). Therefore, no ripple is generated in the power supply voltage (third AVDD) output from the third analog power supply circuit 8. Further, similarly to the second embodiment, a fluctuation-free reference voltage Vi is input to each of the first data signal line driving circuit 2a and the second data signal line driving circuit 2b.

With the above-mentioned configuration, it is also possible to suppress fluctuation (ripple) in the power supply voltage (third AVDD) to be input to the second data signal line driving circuit 2b. Therefore, as compared to the first and second embodiments, degrading of the display quality of the liquid crystal panel 1 can be further prevented.

According to the liquid crystal display device of each of the embodiments described above, fluctuation (ripple) of the power supply voltage to be input to the reference voltage generating circuit can be suppressed. Therefore, a desired gray-scale voltage can be supplied to each data signal line, and degrading of the display quality can be prevented.

While there have been described what are at present considered to be certain embodiments of the invention, it will be understood that various modifications may be made thereto, and it is intended that the appended claims coverall such modifications as fall within the true spirit and scope of the invention.

What is claimed is:

1. A liquid crystal display device, comprising:
a liquid crystal panel including a display portion divided into a plurality of regions that are driven at the same time;
data signal line driving circuits and data signal lines that are individually provided to the respective plurality of regions;
a first analog power supply circuit that is connected to an external power supply, and outputs a first analog voltage to each of the data signal line driving circuits, the first analog voltage being generated based on a power supply voltage output from the external power supply;
a second analog power supply circuit that is connected to the first analog power supply circuit, and outputs a second analog voltage for generating a reference voltage based on the first analog voltage output from the first analog power supply circuit; and
a reference voltage generating circuit that is connected to the second analog power supply circuit, generates the reference voltage based on the second analog voltage output from the second analog power supply circuit, and outputs the generated reference voltage to the each of the data signal line driving circuits,
wherein the each of the data signal line driving circuits generates, based on the reference voltage, a gray-scale voltage to be supplied to each of the data signal lines.

2. The liquid crystal display device according to claim 1, wherein the first analog power supply circuit and the second analog power supply circuit have different circuit configurations.

3. The liquid crystal display device according to claim 2, wherein the first analog power supply circuit has a configuration of a switching regulator, and the second analog power supply circuit has a configuration of a linear regulator.

4. A liquid crystal display device, comprising:
a liquid crystal panel including a display portion divided into a plurality of regions that are driven at the same time;
data signal line driving circuits and data signal lines that are individually provided to the respective plurality of regions;
a first analog power supply circuit that is connected to an external power supply, and outputs a first analog voltage to each of the data signal line driving circuits, the first analog voltage being generated based on a power supply voltage output from the external power supply;
a second analog power supply circuit that is connected to the external power supply, and outputs a second analog voltage for generating a reference voltage based on the power supply voltage output from the external power supply; and
a reference voltage generating circuit that is connected to the second analog power supply circuit, generates the reference voltage based on the second analog voltage output from the second analog power supply circuit, and outputs the generated reference voltage to the each of the data signal line driving circuits,
wherein the each of the data signal line driving circuits generates, based on the reference voltage, a gray-scale voltage to be supplied to each of the data signal lines.

5. The liquid crystal display device according to claim 4, wherein the first analog power supply circuit and the second analog power supply circuit each have the same circuit configuration.

6. The liquid crystal display device according to claim 5, wherein the first analog power supply circuit and the second analog power supply circuit each have a configuration of one of a switching regulator and a linear regulator.

7. A liquid crystal display device, comprising:
a liquid crystal panel including a display portion divided into a plurality of regions that are driven at the same time;
a plurality of data signal line driving circuits and data signal lines that are individually provided to the respective plurality of regions,
the plurality of data signal line driving circuits comprising a first data signal line driving circuit and a second data signal line driving circuit;
a first analog power supply circuit that is connected to an external power supply, and outputs, to the first data signal line driving circuit, a first analog voltage generated based on a power supply voltage output from the external power supply;
a second analog power supply circuit that is connected to the external power supply, and outputs a second analog voltage for generating a reference voltage based on the power supply voltage output from the external power supply;
a third analog power supply circuit that is connected to the external power supply, and outputs, to the second data signal line driving circuit, a third analog voltage generated based on the power supply voltage output from the external power supply; and
a reference voltage generating circuit that is connected to the second analog power supply circuit, generates the reference voltage based on the second analog voltage output from the second analog power supply circuit, and outputs the generated reference voltage to each of the first data signal line driving circuit and the second data signal line driving circuit,
wherein each of the first data signal line driving circuit and the second data signal line driving circuit generates, based on the reference voltage, a gray-scale voltage to be supplied to each of the data signal lines.

8. The liquid crystal display device according to claim 7, wherein the first analog power supply circuit, the second analog power supply circuit, and the third analog power supply circuit each have the same circuit configuration.

9. The liquid crystal display device according to claim 8, wherein the first analog power supply circuit, the second analog power supply circuit, and the third analog power supply circuit each have a configuration of one of a switching regulator and a linear regulator.
